(19) United States
(12) Patent Application Publication
(10) Pub. No.: US 2026/0359942 A1
(43) Pub. Date: Nov. 12, 2026

(54) PREVENTING PERFORMANCE DEGRADATION OF NEURAL NETWORK MODEL ANALYTICS IN AN IMAGING SYSTEM

(71) Applicant: GE Precision Healthcare LLC, Waukesha, WI (US)

(72) Inventors: Sathish Ramani, Niskayuna, NY (US); Pengwei Wu, Clifton Park, NY (US); Lin Fu, Niskayuna, NY (US); Jed Pack, Glenville, NY (US); Mamatha Venugopal, Bengaluru (IN); Muhan Shao, Clifton Park, NY (US); Jhimli Mitra, Niskayuna, NY (US); Bruno De Man, Clifton Park, NY (US)

(21) Appl. No.: 19/202,476

(22) Filed: May 8, 2025

(51) Int. Cl. G06T 5/60

(52) U.S. Cl. CPC G06T 5/60; G06T 2207/10081; G06T 2207/20081; G06T 2207/20084

(57) ABSTRACT

Various implementations disclosed herein include devices, systems, and methods that reduce performance degradation of a deep learning network used for imaging systems. For example, a method may obtain image indicator data associated with at least one input image and in response, an occurrence of a behavioral deviation (BD) with respect to an expected behavior of an image analytics DL network associated with operation of the imaging system may be detected. The method may further determine that the BD is associated with image-properties of the at least one input image deviating from image-properties of training images and in response adaptively modify operation of the imaging system to compensate for the BD.

### TECHNICAL FIELD

The present disclosure generally relates to systems, methods, and devices that reduce performance degradation of deep learning (DL) networks used for imaging systems such as, medical imaging systems.

### BACKGROUND

Existing techniques for performing image analytics may be improved with respect to predictability and accuracy to provide lower deviation from expected behavior.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, an imaging system performing image acquisition and analytics is provided. The system includes one or more processors coupled to computer-readable storage device that includes program instructions that, when executed by the one or more processors, cause the system to perform operations that include: obtaining image indicator data associated with at least one input image; based on the image indicator data, detecting an occurrence of a behavioral deviation (BD) with respect to an expected behavior of an image analytics deep learning (DL) network associated with operation of the imaging system; determining that the BD is associated with image-properties of at least one input image that deviate from image-properties of DL network training images; and adaptively modifying operation of the imaging system to compensate for the BD.

In one embodiment, a method for performing image analytics is provided. The method includes obtaining image indicator data associated with at least one input image; based on the image indicator data, detecting an occurrence of a behavioral deviation (BD) with respect to an expected behavior of an image analytics deep learning (DL) network associated with operation of the imaging system; determining that the BD is associated with image-properties of at least one input image that deviate from image-properties of DL network training images; and adaptively modifying operation of the imaging system to compensate for the BD.

In one embodiment, a non-transitory computer-readable storage medium is provided. The non-transitory computer-readable storage medium includes instructions executable via one or more processors to perform operations comprising: obtaining image indicator data associated with at least one input image; based on the image indicator data, detecting an occurrence of a behavioral deviation (BD) with respect to an expected behavior of an image analytics deep learning (DL) network associated with operation of the imaging system; determining that the BD is associated with image-properties of at least one input image that deviate from image-properties of DL network training images; and adaptively modifying operation of the imaging system to compensate for the BD.

In accordance with some implementations, a device includes one or more processors, a memory, and one or more programs; the one or more programs are stored in the memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example of an imaging system, in accordance with some implementations.

FIG. 2 illustrates a framework for implementing a self-correcting DL network, in accordance with some implementations.

FIG. 3 illustrates an example of reactive and non-reactive layers in a neural network trained via a self-supervised autoencoder, in accordance with some implementations.

FIG. 4 illustrates an exemplary method for adaptively processing images to compensate for BDs, in accordance with some implementations

FIG. 5 illustrates an exemplary method for training image analytics to adapt to BDs by using BD indicators as additional inputs, in accordance with some implementations.

FIG. 6 is a flowchart representation of an exemplary method that reduces performance degradation of a DL network used for imaging systems, in accordance with some implementations.

FIG. 7 illustrates a device for improving imaging system technology, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

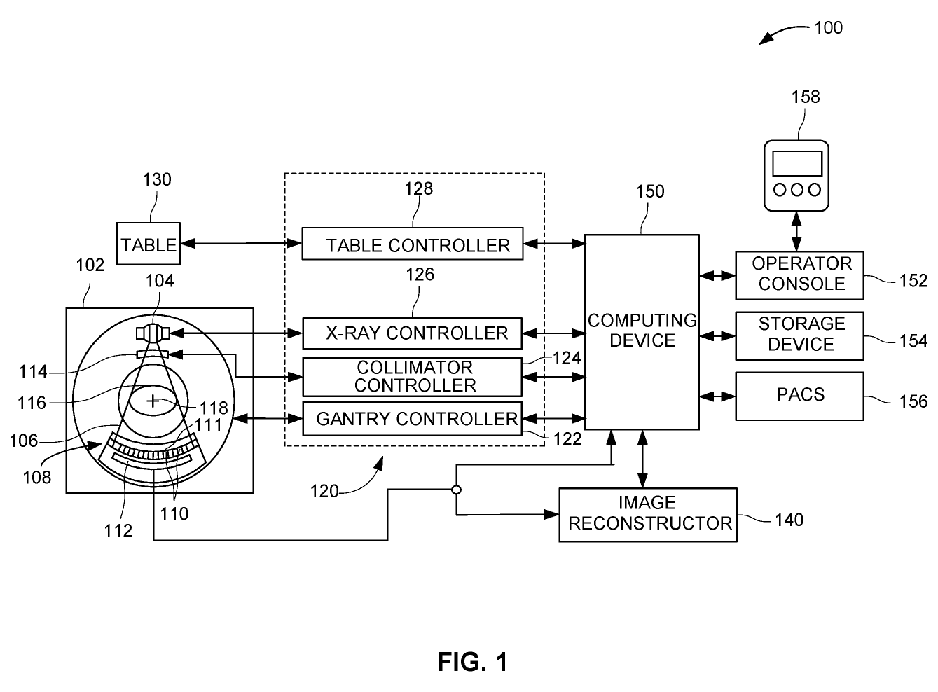

FIG. 1 illustrates an example of an imaging system 100, in accordance with some implementations. In some implementations, the imaging system 100 (e.g., a medical imaging system) is configured to reduce performance degradation of a deep learning (DL) network (e.g., a deep learning model) used for imaging systems. In some implementations, a DL network may be based on artificial neural networks, and may therefore encompass one or more of deep neural networks, fully connected networks, convolutional neural networks (CNNs), vision transformers, unrolled neural networks, perceptrons, encoders-decoders, recurrent networks, wavelet filter banks, u-nets, generative adversarial networks (GANs), dense neural networks, or other neural network architectures. The neural networks may include shortcuts, activations, batch-normalization layers, and/or other data-processing steps or layers. These techniques are referred to herein as DL techniques, though this terminology may also be used specifically in reference to the use of deep neural networks, which is a neural network having a plurality of layers.

In some instances, DL networks may be configured to perform image analytics tasks in a wide range of applications including detection, estimation, classification, segmentation, etc. For example, a DL network may be trained to learn application-specific tasks that are then validated, tested and deployed in commercial systems to perform such tasks under the assumption that real-world data behaves in a similar manner as training data. In contrast, real-world data (e.g., images) may deviate from data and images used during training (e.g., due to a change in demographic population being imaged using an X-ray computed tomography (CT) scanner, due to a change in systems that acquire data (e.g., a new scanner model, X-ray source or X-ray tube aging, change in spectral characteristics of a digital detector, etc.), due to a change in raw data pre-processing methods that manipulate input to DL networks, a change in post-processing methods that use the DL network output for quantitative analysis or diagnoses, etc.). As a result, an outcome of image analytics may become less predictable and/or they may exhibit behavioral deviations (BDs) (i.e., deviations from expected behavior in such scenarios) that may be difficult to resolve.

Accordingly, imaging system 100 is configured to reduce performance degradation of DL network by compensating for BDs that may impact performance by: detecting BDs, detecting deviations in image properties, enabling compensation mechanisms, and defining thresholds and performing root-cause analysis.

In some implementations, detecting BDs may include (a) comparing input images with respect to expected behavior learned during DL network training; (b) using various indicators such as, inter alia: image indicators (e.g., image quality, raw data analysis, artifacts, etc.), EHS record indicators (e.g., metadata or electronic health system (EHS) record data that may signal anomalies, etc.), and/or digital imaging and communications in medicine records (DICOM) header indicators such as scanner-dependent parameters (e.g., voxel size, reconstruction kernel, scanner type, scan parameters, etc.); (c) comparing anan output of its subsequent processing steps with respect to an expected behavior of the DL network on an initial or original system (e.g., without X-ray source or X-ray tube aging, change in spectral characteristics of X-ray detector, or pre- and post-processing software) using physical or numerical testing objects or datasets; and (d) comparing the activations (or associated statistical distribution) of the latent feature space of the DL network with respect to the expected behavior learned during DL network training.

In some implementations, detecting deviations in image properties may include identifying discrepancies in resolution, noise, texture, artifacts, and scanner-specific variations with respect to a training data set.

In some implementations, enabling compensation mechanisms may include: (a) performing analytical or DL-based harmonization by using models trained with controlled BDs to correct deviations; (b) using foundation models by applying pre-trained models capable of correcting BDs to enhance robustness; (c) training with BD indicators to make an original DL network resilient by including BD indicators during training; (d) applying trained networks to handle BDs during inference; and (e) using (generative) neural style-transfer techniques to make input images look and behave more like training data.

In some implementations, defining thresholds and performing root-cause analysis may include defining thresholds for significant BDs and estimating associated root causes to guide appropriate compensation strategies.

In some implementations, the imaging system 100 may be a computed tomography (CT) imaging system 100. The CT imaging system 100 includes associated hardware and software components including, inter alia, a gantry 102, which in turn, includes an X-ray source 104 configured to project a beam of X-rays 106 at a subject or patient 116 being scanned. Specifically, the X-ray source 104 is configured to project the X-ray beam 106 towards an X-ray detector assembly 108 positioned opposite the X-ray source 104. The X-ray source 104 projects the X-ray beam 106 through a pre-patient collimator assembly 114 that focuses, filters, and shapes the X-ray beam 106.

The X-ray detector assembly 108 includes a post-patient collimator assembly 111 and a plurality of detector modules 110 (e.g., detector elements or sensors). The plurality of detector modules 110 detect attenuated X-rays that pass through the subject or patient 116 being scanned. Each detector module 110 produces analog data that represent the intensity of attenuated X-rays. The X-ray detector assembly 108 includes a data acquisition system (DAS) 112 that is coupled to the plurality of detector modules 110. During a scan to acquire image projection data, the X-ray source 104 and the X-ray detector assembly 108 are rotated by a rotating gantry assembly of the gantry 102 around a subject or patient 116 and about a center of rotation 118 (e.g., isocenter) to collect X-ray attenuation data from a plurality of view angles relative to an imaged volume of the subject or patient 116 being scanned.

The X-ray detector assembly 108 collects data of attenuated X-rays that is transferred to the DAS 112. The DAS 112 is configured to sample analog data received from the detector modules 110 and convert the analog data to digital data for subsequent processing. The analog data sampled and digitized by the DAS 112 is transmitted to a computing device 150 and/or an image reconstructor 140.

As mentioned above, the DAS 112 samples and digitizes the image projection data acquired by the detector modules 110. Subsequently, the image reconstructor 140 uses the sampled and digitized image projection data to perform high-speed image reconstruction. Although FIG. 1 illustrates the image reconstructor 140 as a separate component, in certain embodiments, the image reconstructor 140 may be included in the computing device 150. Alternatively, the image reconstructor 140 may be absent from the CT imaging system 100 and instead the computing device 150 may perform one or more functions of the image reconstructor 140. Moreover, the image reconstructor 140 may be located locally or remotely, and may be operatively connected to the CT imaging system 100 using a wired or wireless network. In one exemplary embodiment, the image reconstructor 140 may use computing resources in a "cloud" network cluster for the image reconstruction.

The CT imaging system 100 further includes a control system 120 to control certain components of the CT imaging system 100. The control system 120 may include a gantry controller 122 coupled to gantry 102, a collimator controller 124 coupled to pre-patient collimator assembly 114, an X-ray controller 126 coupled to X-ray source 104, and a table controller 128 coupled to a table 130 for controlling operation of the gantry 102, pre-patient collimator assembly 114, X-ray source 104, and table 130. The gantry controller 122 controls rotation and/or position of the gantry 102 based on imaging requirements. The collimator controller 124 controls the length and width of an aperture of the pre-patient collimator 114 (and, thus, the size and shape of X-ray beam 106). The X-ray controller 126 provides power and timing signals to X-ray source 104. The table controller 128 controls operation and movement of a motorized table 130 (e.g., a patient table) and a moveable cradle that supports and positions a subject or patient 116 through an opening or bore of the gantry 102. For example, the table cradle may move portions of the subject or patient through the opening or bore of the gantry 102.

A computing device 150 provides commands and parameters to one or more of the gantry controller 122, collimator controller 124, X-ray controller 126, and table controller 128 for controlling system operations such as data acquisition and/or processing. In certain embodiments, the computing device 150 controls system operations based on operator input. The computing device 216 receives the operator input, for example, including commands and/or scanning parameters via an operator console 152 operatively coupled to the computing device 150. The operator console 152 maybe coupled to a display monitor 158, including a user interface, to allow the operator or technologist to input commands and/or scanning parameters, and/or viewing data and images. In certain embodiments, the imaging system 100 may be coupled to multiple displays, printers, workstations, and/or similar devices located either locally or remotely, for example, within an institution or hospital, or in an entirely different location via one or more configurable wired and/or wireless networks such as the Internet and/or virtual private networks, wireless telephone networks, wireless local area networks, wired local area networks, wireless wide area networks, wired wide area networks, etc.

In addition to the operator console 152, the computing device 150 may be coupled to a storage device 154, a picture archiving and communications system (PACS) 156, and the image reconstructor 140. In one example, the computing device 150 stores data in the storage device 154. The storage device 154, for example, may include a hard disk drive, a floppy disk drive, a compact disk-read/write (CD-R/W) drive, a Digital Versatile Disc (DVD) drive, a flash drive, and/or a solid-state storage drive. In an exemplary implementation, the PACS 156 may be further coupled to a remote system such as a radiology information system (RIS), hospital information system (HIS), and/or an internal or external network (not shown) to allow operators, technologists, or radiologists at different locations to supply commands and parameters and/or gain access to image data.

Reconstructed images from the image reconstructor 140 may be applied as an input to a computing device 150, which may store the reconstructed images in storage device 154. In some implementations, computing device 150 may be configured to receive commands and scanning parameters from an operator or technologist via operator console 152 and associated display monitor 158 may allow the operator or technologist to observe the scan protocols and reconstructed images and other data. The operator supplied commands and parameters may be used by computing device 150 to provide control signals and information to control system 120, including gantry controller 122, collimator controller 124, X-ray controller 126, and table controller 128.

CT imaging system 100 may include a plurality of processing components (e.g., microprocessors or processing circuitry), memory, and/or storage devices that may be included within control system 120 and/or computing device 150, and may be used to execute stored software code, firmware code, instructions, or routines for acquiring and processing image or CT image data. The term "code" or "software code" or “firmware code” used herein refers to any instructions or set of instructions that control CT imaging system 100. The code or software code or firmware code may exist in a computer-executable form, such as machine code, which is the set of instructions and data directly executed by the processing component, human-understandable form, such as source code, which may be compiled in order to be executed by the processing component, or an intermediate form, such as object code, which is produced by a compiler.

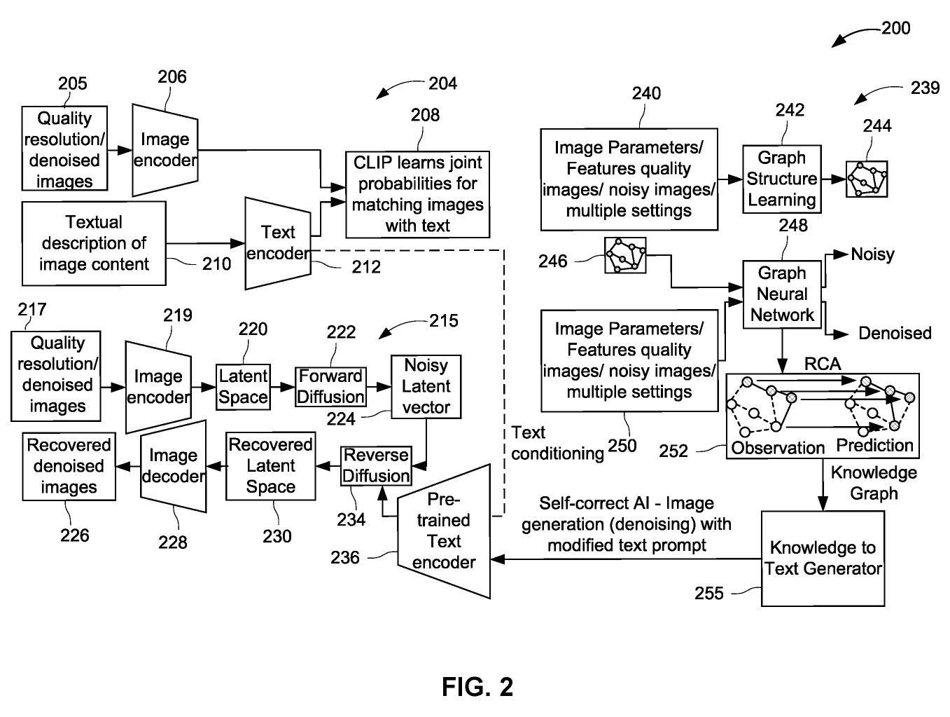

FIG. 2 illustrates a framework 200 for implementing a self- correcting DL network in accordance with some implementations. In some implementations, framework 200 is configured to execute three stages including: a contrastive language-image pretraining (CLIP) model training stage 204, a foundation model training stage 215, and a root cause evaluation and analysis stage 239.

In some implementations, CLIP model training stage 204 may be enabled to capture semantic similarities between text and image data for use as a baseline for evaluating image quality and detecting BDs. For example, a CLIP model may be trained using quality resolution/denoised images 205 and textual descriptions of image content 210 to enable the CLIP model to recognize a relationship between quality resolution/denoised images 205 and textual descriptions of image content 210. The CLIP model training process may include training two networks simultaneously. For example, a first network may be configured to enable an image encoder 206 (e.g., a vision transformer) to process (e.g., resize, crop, etc.) quality resolution/denoised images 205 obtained for example from a diffusion model, a preprocessed dataset, etc. Likewise, a second network may be configured to enable a text encoder 212 (e.g., a transformer model) to process (e.g., tokenize) the textual descriptions of the image content 210 (e.g., captions or metadata). Subsequently in step 208, the CLIP model is configured to use the output from image encoder 206 and text encoder 210 to learn joint probabilities for matching images with text thereby generating a pretrained CLIP model capable of generating embeddings for input images and text descriptions that allow for distinguishing between normal and degraded images based on associated textual descriptions.

In some implementations, the foundation model training stage 215 may be enabled to use a diffusion process guided by textual descriptions to detect, evaluate, and correct BDs by learning a mapping from degraded to corrected representations. For example, the training process may include obtaining quality resolution/denoised images 217 for input into an image encoder 219 configured to convert the quality resolution/denoised images 217 into latent representations (e.g., vectors) in latent space 220. Subsequently, a forward diffusion module 222 is configured to add noise to the latent representations thereby creating noisy latent vector/representation(s) 224. Likewise, a pretrained text encoder 236 may be configured to provide text-based guidance for input (in combination with noisy latent vector/representation(s)) 224 into a reverse diffusion module 234 for enabling a denoising (reverse diffusion) process to reconstruct latent representations in recovered latent space 230. The reconstructed latent representations may be sent to an image decoder 228 to convert the reconstructed latent representations back to a high-quality denoised image(s) 226.

In some implementations, the root cause evaluation and analysis stage 239 may be enabled to identify potential root causes of BDs and refine correction mechanisms. For example, a graph structure learning module 242 may accept as input, data 240 that includes image parameters/features (e.g., brightness, contrast, etc.), quality and noisy images (e.g., generated or real), and multiple settings (e.g., hyperparameters, text prompts, image conditioning, etc.) for generating a graph structure 244 (i.e., including nodes representing features and images and edges representing relationships) for input as a graph structure representation 246 (in combination with data 250 that includes image parameters/features, quality and noisy images, and multiple settings) into a neural network 248. In some implementations, graph structure learning module 242 is configured to identify dependencies and relationships between inputs and a quality of generated images. In some implementations, an output from neural network 248 may be configured to generate a root cause analysis (RCA) structure 252 representing a mapping between an observation and a prediction for input into a knowledge to text generator 255 configured to generate corrective textual descriptions based on the RCA structure 252 and improve artificial intelligence (AI)-based image generation by modifying text prompts or adjusting input parameters for input into pre-trained text encoder 236 for use during the foundation model training stage 215.

Accordingly, CLIP model training stage 204 may provide a robust baseline for identifying and comparing degraded images, foundation model training stage 215 may provide a learning process for correcting BDs by modifying latent representations or preprocessing, and root cause evaluation and analysis stage 239 may provide probabilistic maps for refining correction mechanisms based on detected BD types. In some cases, images may exhibit unanticipated or severe BDs that are unable to be corrected by the proposed framework. However, these events can be detected by the proposed framework due to, for example, a large impact of these BDs on latent space distributions. Such detections are useful as they may indicate the need to expand network training to incorporate a wider variety of images. For example, some patients may have unexpected anatomy (e.g., due to situs inversus) or have metal implants that produce very severe artifacts. Additionally, the network may be adapted to produce not only the standard predictions, but also to self-assess the confidence level that may be assigned to these predictions. These confidence levels can be leveraged in later processing steps. For example, a segmentation obtained from an extremely noisy image may have lower confidence near the boundary pixels or a segmentation may be compromised near a metal artifact.

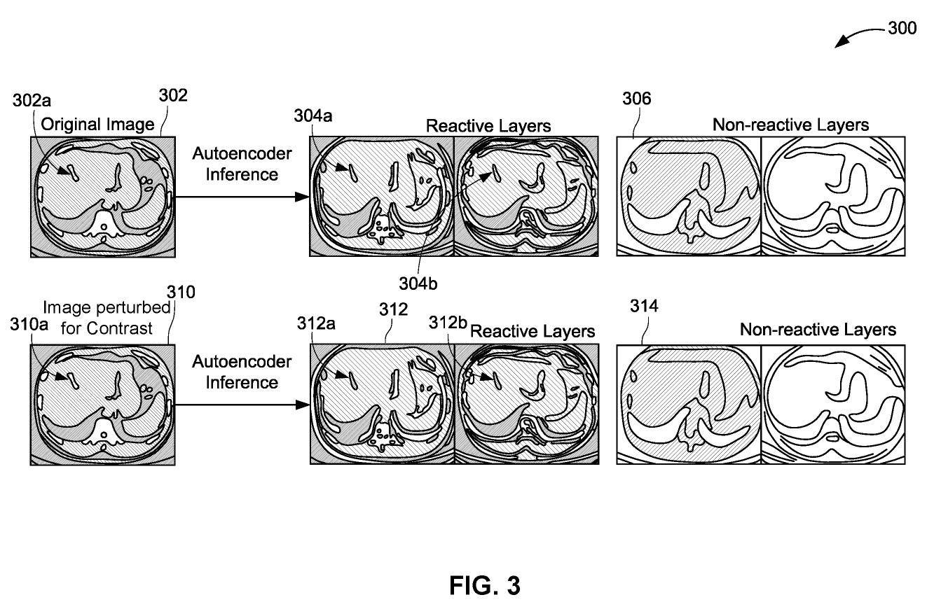

FIG. 3 illustrates an example 300 of reactive and non-reactive layers in a neural network trained via a self-supervised autoencoder, in accordance with some implementations. For example, an original image 302 (e.g., a CT scan of a user) may utilize the inference of a pre-trained autoencoder to retrieve its latent space representations. In some implementations, the image 302 when perturbed for contrast as in image 310, may utilize an autoencoder inference and compare its latent space representation to the original, to be split into reactive layer representations such as in 312 and non-reactive layer representations such as in 314.

In some implementations, non-reactive layer representations such as in 314 may not be sensitive to perturbations in image 310 (e.g., changes in contrast, noise, or other attributes). For example, when the contrast of original image 302 comprising features (e.g., a blood vessel) is modified (e.g., perturbed) with respect to image 310, the non-reactive layer representation 314 does not show any noticeable changes in their feature maps with respect to non-reactive layer representation 306.

In some implementations, reactive layer representation 312 actively responds to changes in image 310 with respect to original image 302. Accordingly, when a feature 302a of original image 302 is perturbed (e.g., a contrast of a blood vessel is increased) to create feature representation 310a of image 310, the reactive layer representation 312 highlights these changes in their feature maps with respect to the reactive layer representation. For example, feature representations 312a and 312b include differences with respect to feature representations 304a and 304b. The differences between feature representations 312a and 312b and feature representations 304a and 304b allow for detection of anomalous BDs in the input data. Accordingly, reactive layers may be leveraged to detect discrepancies between expected inputs and actual inputs during inference and a foundational model may be trained to modify reactive layer outputs to approximate normal representations.

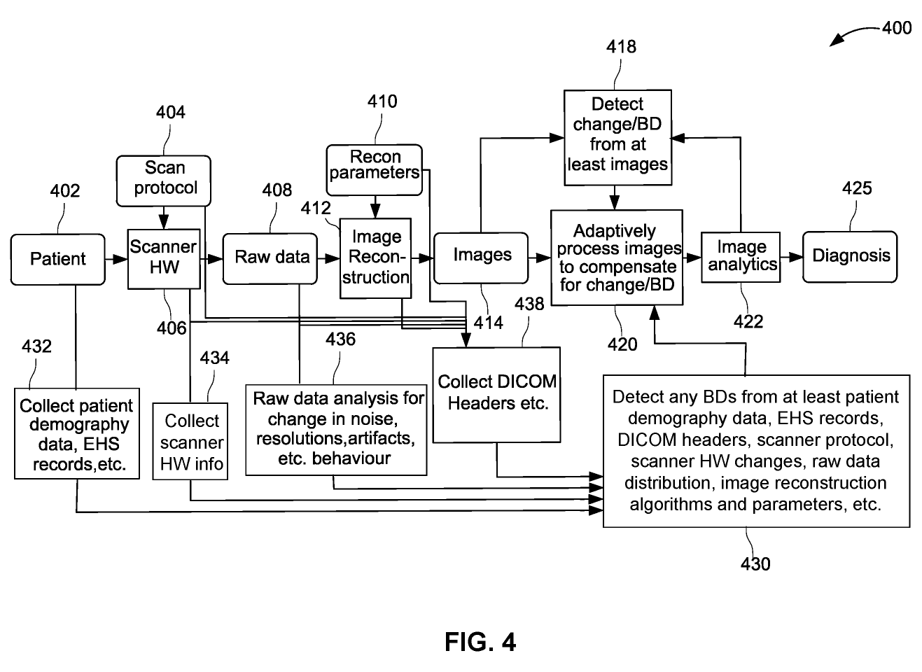

FIG. 4 illustrates an exemplary method 400 for adaptively processing images to compensate for BDs, in accordance with some implementations.

At block 406, scanner hardware (e.g., an imaging system 100 as described with respect to FIG. 1) may be configured to scan a patient 402 using a scanner protocol 404 and acquire raw data 408. The raw data is then processed by an image reconstruction procedure 412 that is configured by reconstruction parameters 410. The output of the image reconstruction is a set of images 414 that can be input to a detection routine 418 to be analyzed for any BDs. The reconstructed images 414 are then input to an adaptive image processing unit 420 which accounts for the detected BDs from 418 and compensates the input images 414 for detected BDs. The output of the adaptive image processing 420 is then input to the image analytics block 422 which should now be less prone to degradation in determining a diagnosis 425 due to BDs as they have been addressed by the adaptive image processing unit 420.

At block 430, additional BDs are detected and input to the adaptive processing unit 420 to further aid in reducing the degradation of the image analytics block 422 in determining a diagnosis 425. The additional BDs may be detected in block 430 by analyzing, inter alia, patient input data for changes in patient population (e.g., age, gender, health conditions, etc.), electronic health system (EHS) records associated with patient demographic changes or health condition shifts over time, etc., both collected by block 432, and digital imaging and communications in medicine records (DICOM) headers for changes in scanner hardware, scan protocols, image reconstruction algorithms and parameters, etc. collected by block 438. Scanner dependent changes may include changes in scanner vendors, models, etc., changes in scanner hardware, changes in scanner behavior (X-ray source or X-ray tube aging, detector aging, etc.), etc. collected by block 434. Scan protocol information 404 may point to changes in scan settings such as kilovolt (KV) settings, milliamp (mA) settings, filter settings, positional settings with respect to the scanner, etc. collected as part of the DICOM headers 438. Reconstruction algorithm 412 and reconstruction parameters 410 may point to changes in reconstruction FOV, image pixel size, reconstruction kernel, etc. Block 436 performs both rudimentary and sophisticated raw data analyses to monitor changes in noise, resolution, artifacts, etc. of a more fundamental nature (e.g., increased detector noise for same scan protocols, increased number of non-functional detector cells, etc.) to further aid in detection of BDs 430.

Changes/BDs are detected from the images 414 at block 418 and/or from meta data 430 (such as patient demography, EHS records, DICOM headers, etc.) collected from blocks 432, 434, 436, and 438, and/or as part of image analytics 422 such as resolution, noise, texture, artifacts, scanner-dependent changes, etc. The detected changes/BDs may be used in block 420 to adaptively compensate the images 414 to compensate for the changes/BDs prior to determining a diagnosis 425 with the compensated and adapted images.

In some implementations, adaptively compensating the images 414 in block 420 may include performing analytical or DL-based harmonization processes to standardize the images 414 to a common baseline. The DL-based harmonization processes may be trained using simulated or measured datasets with controlled BDs. One method of DL-based harmonization includes neural style transfer, which may leverage a generative DL model to produce images that are more in line with network expectations. The resulting images should produce latent space representations that are consistent with the training data in order to mitigate BDs. The analytical-based harmonization processes may include analytical methods such as filtering, normalization, algorithmic corrections, etc.

In some implementations, adaptively compensating the images 414 in block 420 may include training foundation models to generate BD-corrected images by leveraging prompts from a CLIP model (to understand the nature of the BD) and feedback from a root-cause analysis model (to refine corrections).

In some implementations, blocks 418, 420, and 430 may use determined thresholds for detecting significant changes in BD indicators. The thresholds may be determined using simulations and/or controlled experiments.

In some implementations, blocks 418, 420, and 430 may use root-cause analysis to automatically estimate root-causes of changes/BDs using one or more indicators (e.g., EHS records, DICOM headers, image analyses, raw data analyses, image analytics latent space analyses, image analytics uncertainty estimate, etc.) to populate a cause-effect look-up table tying root-causes to BDs such that probabilities of root causes are estimated by: (a) using a machine learning estimator such as a DL model; (b) using a contrastive language-image pretrained (CLIP) network (e.g., multimodal learning to detect patterns); (c) using auto-encoders trained to disentangle BDs from actual anatomical features via, for example, self-supervised learning; (d) training a-c with simulated datasets; (e) training a-c with labeled patient datasets; (f) analyzing latent space (in terms of reactive and non-reactive layers) of a-c by controlled perturbation of specified image properties; and (g) estimating uncertainties and biases in indicators (e.g., EHS records, DICOM headers, image analyses, raw data analyses, image analytics latent space analyses, image analytics uncertainty estimate, etc.) in a controlled setting tying root-causes to BDs.

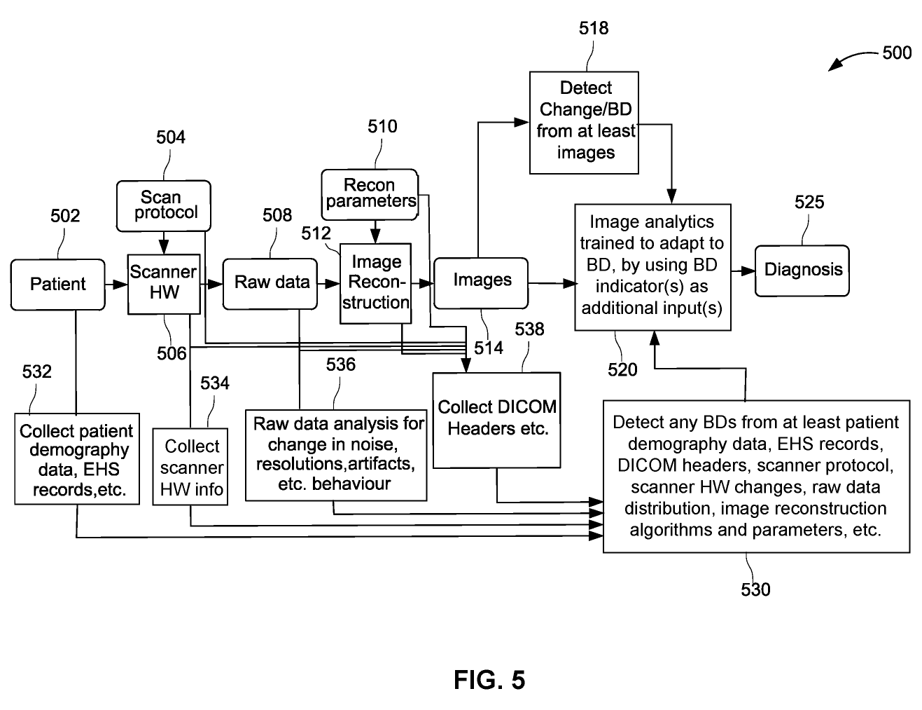

FIG. 5 illustrates an exemplary method 500 for training image analytics to adapt to BDs by using BD indicators as additional inputs, in accordance with some implementations.

At block 506, scanner hardware (e.g., an imaging system 100 as described with respect to FIG. 1) may be configured to scan a patient 502 using a scanner protocol 504 and acquire raw data 508. The raw data is then processed by an image reconstruction procedure 512 that is configured by reconstruction parameters 510. The output of the image reconstruction is a set of images 514 that can be input to a detection routine 518 to be analyzed for any BDs. The reconstructed images 514 are then input directly to an image analytics block 520 that is trained to automatically adapt to BDs in images 514 and avoid degradation in its performance of determining a diagnosis 525.

At block 530, additional BDs are detected and input directly to the image analytics block 520 which is also trained to adapt to additional BDs detected by block 530 to further aid in reducing the degradation of determining a diagnosis 525. The additional BDs may be detected in 530 by analyzing, inter alia, patient input data for changes in patient population (e.g., age, gender, health conditions, etc.), electronic health system (EHS) records associated with patient demographic changes or health condition shifts over time, etc., both collected by block 532, and digital imaging and communications in medicine records (DICOM) headers for changes in scanner hardware, scan protocols, image reconstruction algorithms and parameters, etc. collected by block 538. Scanner dependent changes may include changes in scanner vendors, models, etc., changes in scanner hardware, changes in scanner behavior (X-ray source or X-ray tube aging, detector aging, etc.), etc. collected by block 534. Scan protocol information 504 may point to changes in scan settings such as kilovolt (kV) settings, milliamp (mA) settings, filter settings, positional settings with respect to the scanner, etc. collected as part of the DICOM headers 538. Reconstruction algorithm 512 and reconstruction parameters 510 may point to changes in reconstruction FOV, image pixel size, reconstruction kernel, etc. Block 536 performs both rudimentary and sophisticated raw data analyses to monitor changes in noise, resolution, artifacts, etc. of a more fundamental nature (e.g., increased detector noise for same scan protocols, increased number of non-functional detector cells, etc.) to further aid in detection of BDs 530.

At blocks 518 and 530, changes/BDs are respectively detected from the images 514 and meta data (such as patient demography, EHS records, DICOM headers, etc.) collected from blocks 532, 534, 536, and 538.

At block 520, the image analytics DL network is trained to automatically adjust itself to avoid or reduce, in real-time, the degradation of its ability to determine an accurate diagnosis 525 by directly taking in BD indicator(s) and/or root cause estimates as additional input(s). BD indicators from blocks 518 and 530 may include, inter alia, metadata from DICOM headers (scanner, protocol, reconstruction parameters, etc.), raw data characteristics (e.g., noise, resolution, artifacts, etc.), patient population changes (e.g., EHS records), scanner hardware changes (e.g., aging, replacements, etc.), reactive layers of trained DL networks, root cause estimates using previously trained models (e.g., contrastive models, auto-encoders, CLIP networks, etc.), etc.. The BD indicators may be used to: (a) provide insights into likely causes of BDs, (b) perform real-time adjustments with respect to continuously learning from incoming data, (c) perform adaptive corrections to improve robustness against BDs, or (d) combinations thereof. Training an image analytics DL network may include: (a) enabling supervised learning using labeled datasets with known BDs and associated root causes; (b) enabling self-supervised learning using autoencoders or contrastive learning to identify underlying feature space that is robust to BDs; (c) enabling foundation models guided by CLIP networks to suggest BD corrections; or (d) combinations thereof.

In some implementations, blocks 518, 520 and 530 may use determined thresholds for detecting significant changes in BD indicators. The thresholds may be determined using simulations and/or controlled experiments.

In some implementations, blocks 518, 520, and 530 may use root-cause analysis to automatically estimate root-causes of changes/BDs using one or more indicators (e.g., EHS records, DICOM headers, image analyses, raw data analyses, image analytics latent space analyses, image analytics uncertainty estimate, etc.) to populate a cause-effect look-up table tying root-causes to BDs such that probabilities of root causes are estimated by: (a) using a machine learning estimator such as a DL model; (b) using a contrastive language-image pretrained (CLIP) network (e.g., multimodal learning to detect patterns); (c) using auto-encoders trained to disentangle BDs from actual anatomical features via, for example, self-supervised learning; (d) training a-c with simulated datasets; (e) training a-c with labeled patient datasets; (f) analyzing latent space (in terms of reactive and non-reactive layers) of a-c by controlled perturbation of specified image properties; or (g) estimating uncertainties and biases in indicators (e.g., EHS records, DICOM headers, image analyses, raw data analyses, image analytics latent space analyses, image analytics uncertainty estimate, etc.) in a controlled setting tying root-causes to BDs, whether individually or in combinations thereof.

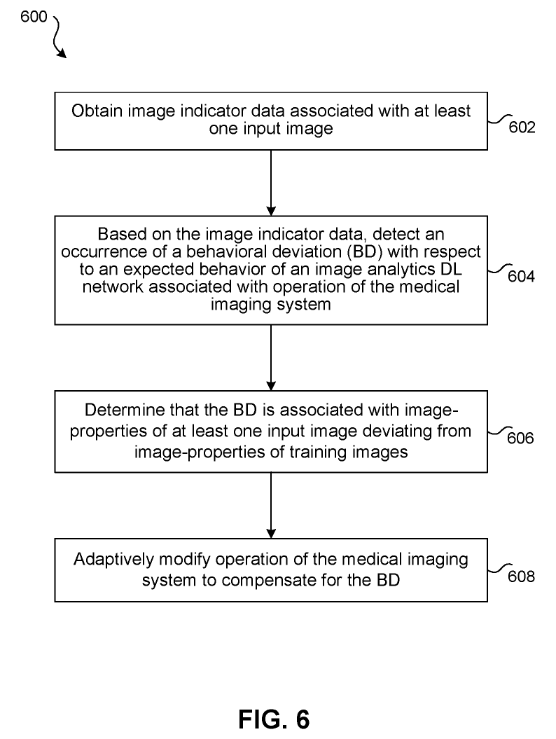

FIG. 6 is a flowchart representation of an exemplary method 600 that reduces performance degradation of a DL network used for imaging systems by detecting and compensating for an occurrence of a BD with respect to an expected behavior of the DL network, in accordance with some implementations. In some implementations, the method 600 is performed by a device or system, such as an imaging system (e.g., a CT scanner), an external server or controller, or any combination thereof. In some implementations, the method 600 is performed by processing logic, including hardware, firmware, software, or a combination thereof. In some implementations, the method 600 is performed by a processor executing code stored in a non-transitory computer-readable medium (e.g., a non-volatile memory or storage medium). Each of the blocks in the method 600 may be enabled and executed in any order.

At block 602, the method 600 obtains image indicator data associated with at least one input image, output image analytics, or intermediate latent features. For example, image indicator data may include image analyses indicator data, raw data analyses indicator data, image analytics latent space analyses indicator data or image analytics uncertainty estimate indicator data as described with respect to FIG. 1 and blocks 418 and 420 of FIG. 4.

In some implementations, the at least one input image may be a CT scan image.

At block 604, the method 600 detects (based on the image indicator data) an occurrence of a behavioral deviation (BD) with respect to an expected behavior of an image analytics DL network associated with operation of the imaging system. For example, a BD may be detected from images 414 and/or meta data 432, 434, 436, and 438 and/or image analytics 422 of FIG. 4.

In some implementations, the method obtains differing indicator data with respect to the image indicator data such that detecting the occurrence of the BD is further based on the differing indicator data. For example, the differing indicator data may include EHS record indicator data, DICOM header indictor data, etc. as described, for example, with respect to blocks 432, 434, 436, and 438 of FIG. 4.

At block 606, the method 600 determines that the BD is associated with image-properties of at the least one input image deviating from image-properties of training images. For example, the at least one input image may deviate from the image-properties of DL network training images with respect to resolution, noise, texture, artifacts, or scanner-dependent changes as described with respect to FIG. 4.

At block 608, the method 600 adaptively modifies operation of the imaging system to compensate (e.g., correct) for the BD. For example, adaptively modifying operation of the imaging system to compensate for the BD may include compensating the at least one input image by executing a (analytical or DL-based) harmonization process trained using (simulated or measured) datasets with controlled BDs as described with respect to FIG. 4.

In some implementations, adaptively modifying operation of the imaging system to compensate for the BD may include compensating the at least one input image by executing at least one foundation model trained to produce BD-corrected images based on prompts from a pretraining model (e.g., a CLIP model) and feedback obtained from a root-cause analysis model as described with respect to blocks 418, 430 and 420 of FIG. 4.

In some implementations, adaptively modifying operation of the imaging system to compensate for the BD may include training the image analytics DL network with the image indicator data to enable the image analytics DL network to automatically adjust itself in real time when BDs are detected as described with respect to block 520 of FIG. 5.

In some implementations, adaptively modifying operation of the imaging system to compensate for the BD may include training the image analytics DL network with a root cause estimate of a root cause of the BD to enable the image analytics DL network to automatically adjust itself in real time when BDs are detected as described with respect to block 520 of FIG. 5.

In some implementations, the method 600 may further execute the image analytics DL network to generate predictions with respect to additional data associated with the imaging system (e.g., inferencing).

In some implementations, the method 600 may further determine thresholds associated with changes in the image indicator data based on simulation data such that adaptively modifying operation of the imaging system to compensate for the BD is based on the thresholds as described with respect to FIG. 5.

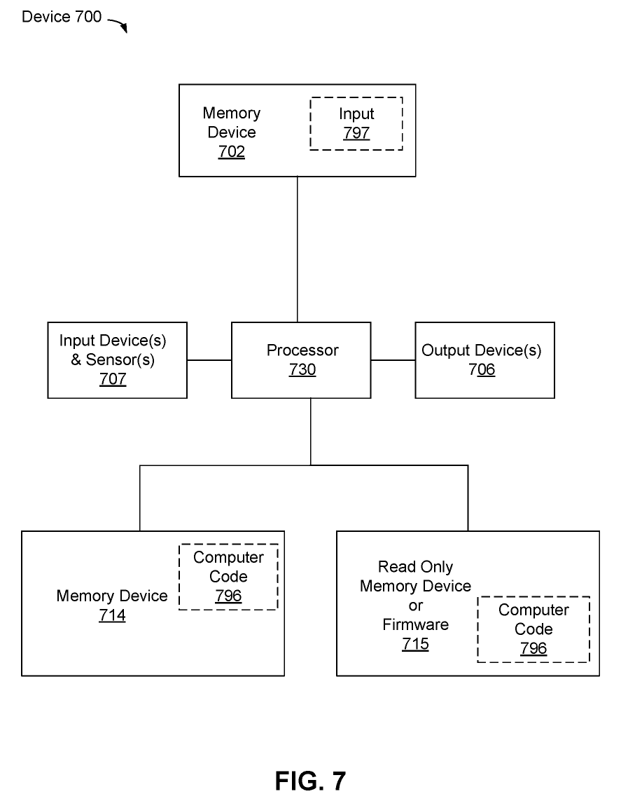

FIG. 7 illustrates devices 700 (e.g., an image scan device or system, a server hardware device, a controller, etc.) for improving imaging system technology associated with reducing performance degradation of a DL network used for imaging systems by detecting and compensating for an occurrence of a BD with respect to an expected behavior of the DL network, in accordance with some implementations.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, device (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The devices 700 illustrated in FIG. 7 includes a processor 730, input device/sensors 707 coupled to the processor 730, an output device 706 coupled to the processor 730, and memory devices 702 and 714 (e.g., non-volatile memory devices) each coupled to the processor 730. The input device/sensors 707 may be, inter alia, a keyboard, a mouse, a camera, a touchscreen, any type of sensors such as an image sensor, a temperature sensor, a voltage/current sensor, etc. The output device 706 may be, inter alia, a printer, a plotter, a computer screen, a magnetic tape, a removable hard disk, a floppy disk, etc. The memory devices 702 and 714 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 714 includes a computer code 796. The computer code 796 includes algorithms (e.g., the algorithms of FIGS. 4-6) for improving imaging system technology associated with reducing performance degradation of a DL network used for imaging systems by detecting and compensating for an occurrence of a BD with respect to an expected behavior of the DL network. The processor 730 executes the computer code 796. The memory device 702 includes input data 797. The input data 797 includes input (e.g., scanned images) required by the computer code 796. The output device 706 displays output from the computer code 796. Either or both memory devices 702 and 714 (or one or more additional memory devices such as read only memory device or firmware 715) may include algorithms (e.g., the algorithms of FIGS. 4-6) and may be used as a computer usable medium (or a computer readable medium or a program storage device) having a computer readable program code embodied therein and/or having other data stored therein, wherein the computer readable program code includes the computer code 796. Generally, a computer program product (or, alternatively, an article of manufacture) of the devices 700 may include the computer usable medium (or the program storage device).

In some embodiments, rather than being stored and accessed from a hard drive, optical disc or other writeable, rewriteable, or removable hardware memory device 714, stored computer program code 796 (e.g., including algorithms) may be stored on a static, nonremovable, read-only storage medium such as a Read-Only Memory (ROM) device 715, or may be accessed by processor 730 directly from such a static, nonremovable, read-only medium 715. Similarly, in some embodiments, stored computer program code 796 may be stored as computer-readable firmware 715, or may be accessed by processor 730 directly from such firmware 715, rather than from a more dynamic or removable hardware data-storage device 714, such as a hard drive or optical disc.

While FIG. 7 shows the devices 700 as a particular configuration of hardware and software, any configuration of hardware and software, as would be known to a person of ordinary skill in the art, may be utilized for the purposes stated supra in conjunction with the particular devices 700 of FIG. 7. For example, the memory devices 702 and 714 may be portions of a single memory device rather than separate memory devices.

While embodiments of the present disclosure have been described herein for purposes of illustration, many modifications and changes will become apparent to those skilled in the art. Accordingly, the appended claims are intended to encompass all such modifications and changes as fall within the true spirit and scope of this disclosure.

What is claimed is:

1. An imaging system comprising:
one or more processors coupled to a computer-readable storage device, wherein the computer-readable storage device comprises program instructions that, when executed by the one or more processors, cause the system to perform operations comprising:
obtaining image indicator data associated with at least one input image, output image analytics, or intermediate latent features;
based on the image indicator data, detecting an occurrence of a behavioral deviation (BD) with respect to an expected behavior of an image analytics deep learning (DL) network associated with operation of the imaging system;
determining that the BD is associated with image-properties of the at least one input image that deviate from image-properties of DL network training images; and
adaptively modifying operation of the imaging system to compensate for the BD.

2. The system of claim 1, wherein said adaptively modifying operation of the imaging system to compensate for the BD comprises:
compensating the at least one input image by executing a harmonization process trained using datasets with controlled BDs.

3. The system of claim 2, wherein the datasets comprise simulated datasets.

4. The system of claim 2, wherein the datasets comprise measured datasets.

5. The system of claim 1, wherein said adaptively modifying operation of the imaging system to compensate for the BD comprises:
compensating the at least one input image by executing at least one foundation model trained to produce BD-corrected images based on prompts from a pretraining model and feedback obtained from a root-cause analysis model.

6. The system of claim 1, wherein said adaptively modifying operation of the imaging system to compensate for the BD comprises:
training the image analytics DL network with the image indicator data to enable the image analytics DL network to automatically adjust itself in real time when BDs are detected.

7. The system of claim 1, wherein said adaptively modifying operation of the imaging system to compensate for the BD comprises:
training the image analytics DL network with a root cause estimate of a root cause of the BD to enable the image analytics DL network to automatically adjust itself in real time when BDs are detected.

8. The system of claim 1, wherein the program instructions, when executed on the one or more processors, further cause the system to perform operations comprising:
executing the image analytics DL network to generate predictions with respect to additional data associated with the imaging system.

9. The system of claim 1, wherein the program instructions, when executed on the one or more processors, further cause the system to perform operations comprising:
based on simulation data, determining thresholds associated with changes in the image indicator data, wherein said adaptively modifying operation of the imaging system to compensate for the BD is based on the thresholds.

10. The system of claim 1, wherein the program instructions, when executed on the one or more processors, further cause the system to perform operations comprising:
obtaining differing indicator data with respect to the image indicator data, wherein said detecting the occurrence of the BD is further based on the differing indicator data.

11. The system of claim 10, wherein the differing indicator data comprises electronic health system (EHS) record indicator data or DICOM header data.

12. The system of claim 1, wherein the at least one input image deviates from the image-properties of training images with respect to resolution, noise, texture, artifacts, or scanner-dependent changes.

13. The system of claim 1, wherein the at least one input image comprises
a computerized tomography (CT) scan image.

14. The system of claim 1, wherein the image indicator data comprises image analyses indicator data, raw data analyses indicator data, image analytics latent space analyses indicator data or image analytics uncertainty estimate indicator data.

15. A method comprising:
an imaging system having a processor:
obtaining image indicator data associated with at least one input image, output image analytics, or intermediate latent features;
based on the image indicator data, detecting an occurrence of a behavioral deviation (BD) with respect to an expected behavior of an image analytics DL network associated with operation of the imaging system;
determining that the BD is associated with image-properties of the at least one input image that deviate from image-properties of DL network training images; and
adaptively modifying operation of the imaging system to compensate for the BD.

16. The method of claim 15, wherein said adaptively modifying operation of the imaging system to compensate for the BD comprises:
compensating the at least one input image by executing a harmonization process trained using datasets with controlled BDs.

17. The method of claim 15, wherein said adaptively modifying operation of the imaging system to compensate for the BD comprises:
compensating the at least one input image by executing at least one foundation model trained to produce BD-corrected images based on prompts from a pretraining model and feedback obtained from a root-cause analysis model.

18. The method of claim 15, wherein said adaptively modifying operation of the imaging system to compensate for the BD comprises:
training the image analytics DL network with the image indicator data to enable the image analytics DL network to automatically adjust itself in real time when BDs are detected.

19. The method of claim 15, wherein said adaptively modifying operation of the imaging system to compensate for the BD comprises:
training the image analytics DL network with a root cause estimate of a root cause of the BD to enable the image analytics DL network to automatically adjust itself in real time when BDs are detected.

20. A non-transitory computer-readable storage medium storing program
instructions executable via one or more processors to perform operations comprising:
obtaining image indicator data associated with at least one input image, output image analytics, or intermediate latent features;
based on the image indicator data, detecting an occurrence of a behavioral deviation (BD) with respect to an expected behavior of an image analytics DL network associated with operation of the imaging system;
determining that the BD is associated with image-properties of the at least one input image that deviate from image-properties of DL network training images; and
adaptively modifying operation of the imaging system to compensate for the BD.
